(19) United States
(12) Patent Application Publication
(10) Pub. No.: US 2024/0364043 A1
(43) Pub. Date: Oct. 31, 2024

(54) CONNECTOR

(71) Applicant: Yazaki Corporation, Tokyo (JP)

(72) Inventors: Tomokazu Iwami, Kakegawa-shi (JP); Shigeyuki Ogasawara, Kakegawa-shi (JP); Shinsuke Aoshima, Fujieda-shi (JP)

(21) Appl. No.: 18/772,030

(22) Filed: Jul. 12, 2024

Related U.S. Application Data
(63) Continuation of application No. PCT/JP2023/004576, filed on Feb. 10, 2023.

(30) Foreign Application Priority Data
Mar. 7, 2022 (JP) 2022-034639

(51) Int. Cl. H01R 13/502; H01R 13/639

(52) U.S. Cl. CPC H01R 13/502; H01R 13/639; H01R 2201/26

(57) ABSTRACT

A connector includes a housing fitted to a counterpart housing, and an actuator assembled to the housing along an intersecting direction with a fitting direction of the housing and the counterpart housing, the actuator includes a detection part configured to detect fitting of the housing and the counterpart housing, and the housing includes a hole portion into which the detection part is inserted, and a guide portion inclined to guide the detection part to the hole portion when the actuator is assembled to the housing.

### CROSS-REFERENCE TO RELATED APPLICATIONS

This is a continuation of International Application No. PCT/JP2023/004576 filed on Feb. 10, 2023, and claims priority from Japanese Patent Application No. 2022-034639 filed on Mar. 7, 2022, the entire content of which is incorporated herein by reference.

### TECHNICAL FIELD

The present invention relates to a connector.

### BACKGROUND ART

When a power storage battery or the like mounted on a vehicle such as an electric automatic vehicle is charged, a power receiving connector connected to the power storage battery and a charging connector connected to a charging device are fitted to supply power to the power storage battery. In general, in order to prevent separation of the charging connector from the power receiving connector, the power receiving connector is provided with a locking mechanism. An actuator may be used as the locking mechanism. As described above, in the related art, a connector including a power receiving connector and an actuator serving as a locking mechanism has been proposed (for example, see Patent Literature 1).

### CITATION LIST

### Patent Literature

Patent Literature 1: JP2018-156826A

### SUMMARY OF INVENTION

As described above, among the connectors of the related art including the actuator, there is a connector in which the actuator has a detection pin for detecting fitting of the power receiving connector and the charging connector. In such a connector, for example, when the actuator is assembled to the power receiving connector, the detection pin is inserted into a hole portion of the power receiving connector. When the power receiving connector and the charging connector are fitted to each other, the detection pin inserted into the hole portion abuts against the charging connector. Accordingly, the fitting between the power receiving connector and the charging connector is detected, and the separation of the charging connector from the power receiving connector is prevented by a come-off prevention mechanism or the like of the actuator.

In some cases, the detection pins inserted into the power receiving connector and the charging connector are provided so as to extend along a fitting direction of the power receiving connector and the charging connector. In the case where the detection pin has the configuration described above, for example, if an assembling direction of the actuator to the power receiving connector is a direction intersecting the fitting direction, when the actuator is assembled to the power receiving connector, the detection pin may interfere with a portion (for example, a housing or the like) of the power receiving connector other than the hole portion. Accordingly, since a work of inserting the detection pin into the hole portion of the power receiving connector (that is, an assembly work of the actuator to the power receiving connector) is complicated, the connector of the related art has room for improvement in terms of workability.

A connector according to an embodiment is excellent in workability of an assembly work of an actuator to a housing.

A connector according to one embodiment including:
a housing fitted to a counterpart housing; and
an actuator assembled to the housing along an intersecting direction with a fitting direction of the housing and the counterpart housing, in which
the actuator includes
   a detection part configured to detect fitting of the housing and the counterpart housing, and
the housing includes
   a hole portion into which the detection part is inserted, and
   a guide portion inclined to guide the detection part to the hole portion when the actuator is assembled to the housing.

In the connector according to the embodiment, the actuator assembled to the housing fitted to the counterpart housing includes the detection part that is inserted into the hole portion of the housing to detect the fitting between the housing and the counterpart housing. Further, the housing includes the guide portion inclined to guide the detection part to the hole portion when the actuator is assembled. Accordingly, when the actuator is assembled to the housing, interference of the detection part with a portion of the housing other than the hole portion and the guide portion is prevented. In other words, the connector having the above configuration is superior to a connector of the related art in workability in an assembly work of the actuator to the housing, and the like.

### BRIEF DESCRIPTION OF DRAWINGS

FIG. 1 is a perspective view of a connector according to an embodiment of the present invention;

FIG. 2 is a cross-sectional view taken along a line A-A in FIG. 1;

FIG. 3 is a perspective view illustrating a housing of the connector illustrated in FIG. 1;

FIG. 4 is an enlarged view of a portion B in FIG. 3;

FIG. 5 is a cross-sectional view taken along a line C-C in FIG. 3;

FIG. 6 is a first view illustrating an assembly step of an actuator to a housing of a connector according to another embodiment, and is a view corresponding to a portion D in FIG. 5;

FIG. 7 is a second view illustrating the assembly step of the actuator to the housing of the connector illustrated in FIG. 6, and is a view corresponding to the portion D in FIG. 5; and

FIG. 8 is a third view illustrating the assembly step of the actuator to the housing of the connector illustrated in FIG. 6, and is a view corresponding to the portion D in FIG. 5.

### DESCRIPTION OF EMBODIMENTS

### Embodiment

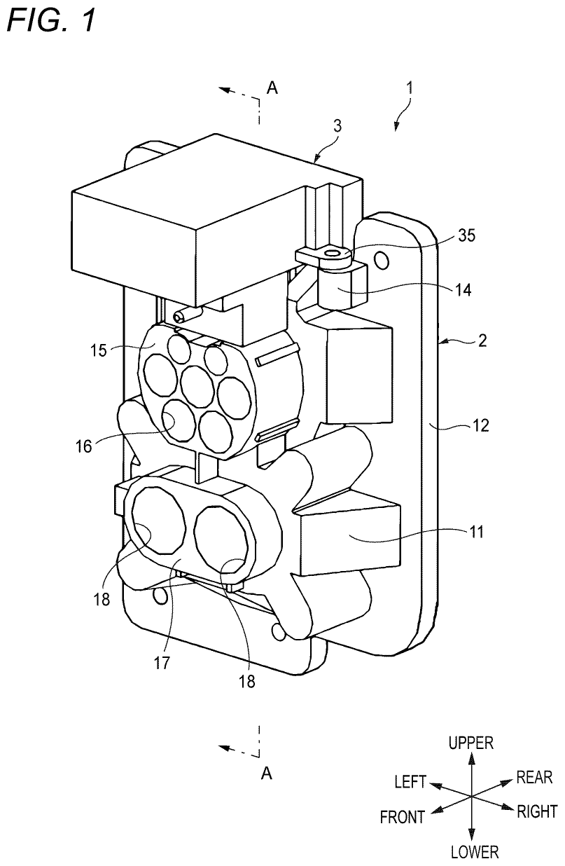

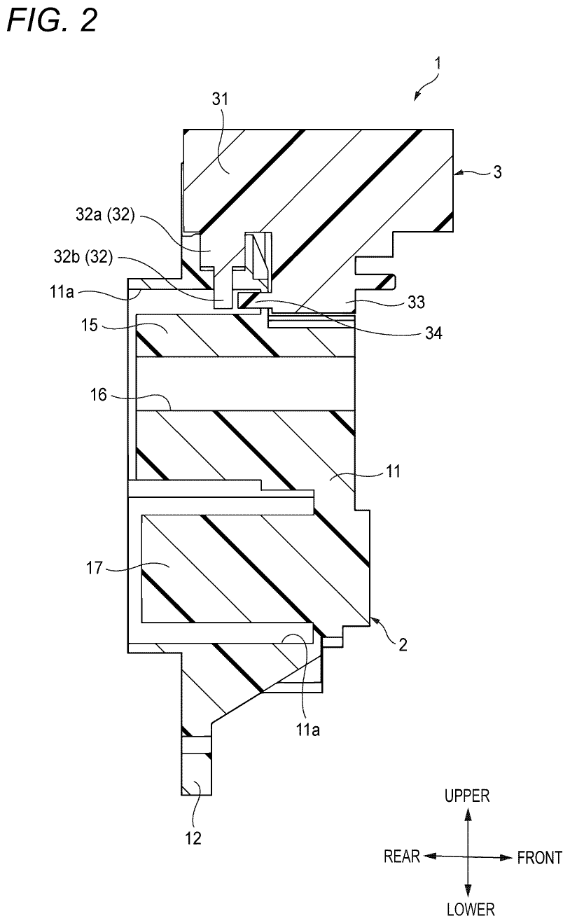

Hereinafter, a connector 1 according to an embodiment of the present invention illustrated in FIGS. 1 and 2 will be described with reference to the drawings. The connector 1 is typically a power receiving connector (so-called inlet) mounted on a vehicle such as a hybrid vehicle or an electric automatic vehicle. The connector 1 is electrically connected to, for example, a charging connector (so-called charging gun, not illustrated) connected to a power supply device outside the vehicle. A “counterpart housing” according to the present invention is, for example, a housing of a charging connector. Hereinafter, a connector (for example, a charging connector) having a counterpart housing is referred to as a “counterpart connector”.

Hereinafter, for convenience of description, as illustrated in FIGS. 1 to 8, “front”, “rear”, “left”, “right”, “upper”, and “lower” are defined. A “front-rear direction”, a “left-right direction”, and an “upper-lower direction” are orthogonal to one another. The upper-lower direction is a direction in which an actuator 3 is assembled to a housing 2, and corresponds to an “intersecting direction”. The front-rear direction corresponds to a fitting direction of the housing 2 and the counterpart housing.

As illustrated in FIGS. 1 and 2, the connector 1 includes the housing 2 fitted to the counterpart housing (not illustrated) and the actuator 3 assembled to the housing 2 along the upper-lower direction. Hereinafter, the housing 2 and the actuator 3 constituting the connector 1 will be described in order.

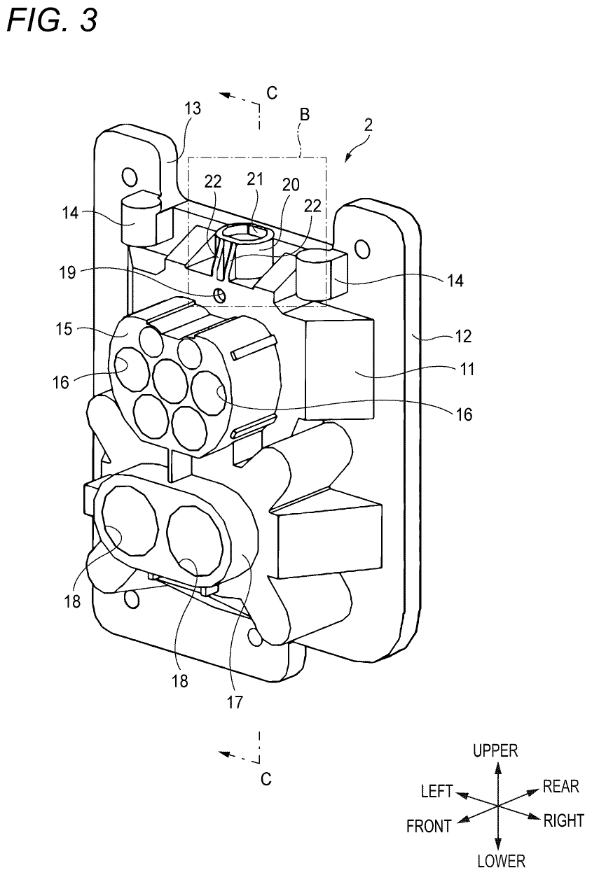

First, the housing 2 will be described. As illustrated in FIGS. 3 to 5, the housing 2 integrally includes a body portion 11 having a hood portion 11a and a flange portion 12 extending outward from an outer periphery surface of the hood portion 11a. In the body portion 11, a first terminal accommodating portion 15 in which a plurality of (seven in this example) terminal accommodating chambers 16 are provided and a second terminal accommodating portion 17 in which a pair of terminal accommodating chambers 18 are arranged side by side in the left-right direction are arranged side by side at a predetermined interval in the upper-lower direction.

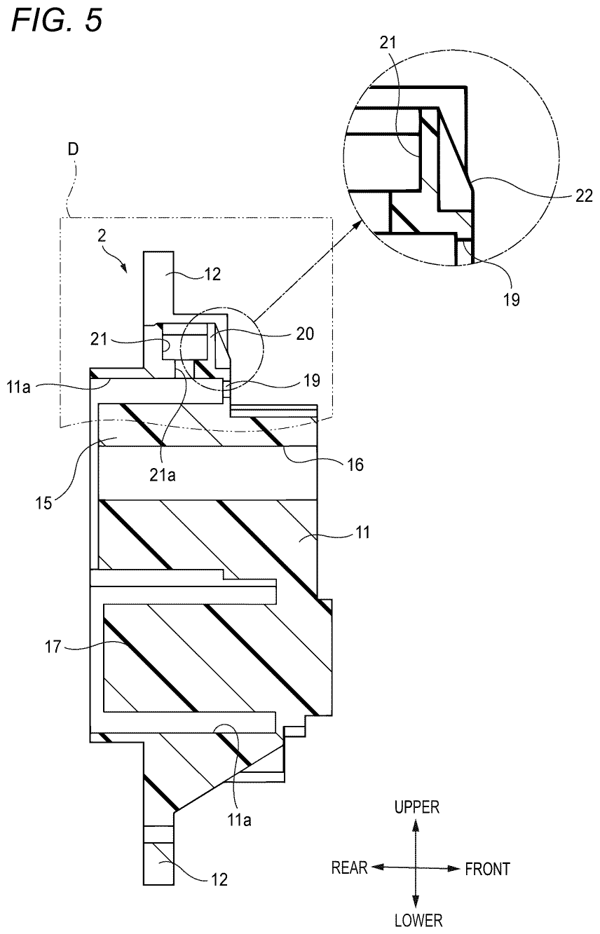

The first terminal accommodating portion 15 and the second terminal accommodating portion 17 are collectively covered by the hood portion 11a from a substantially central portion to a rear end portion in the front-rear direction (see FIG. 5) and protrude forward from a front end surface of the body portion 11 from the substantially central portion to a front end portion in the front-rear direction (see FIG. 3).

The corresponding terminals are accommodated in the respective terminal accommodating chambers 16 and 18. When the terminal is accommodated in each terminal accommodating chamber 16, the first terminal accommodating portion 15 and the terminal constitute a connecting portion to the counterpart connector. Similarly, when the terminal is accommodated in each terminal accommodating chamber 18, the second terminal accommodating portion 17 and the terminal constitute a connecting portion to the counterpart connector. For example, the connecting portion constituted by the first terminal accommodating portion 15 and the terminal is used as a power receiving portion for normal charging, and the connecting portion constituted by the second terminal accommodating portion 17 and the terminal is used as a power receiving portion for quick charging.

In particular, as illustrated in FIG. 3, a notch portion 13 recessed downward is provided at an upper end edge of the flange portion 12. The notch portion 13 is provided at a substantially central portion in the left-right direction, and has a shape corresponding to an outer shape of a body portion 31 of the actuator 3 to be described later. A support portion 14 on which a fastening portion 35 of the actuator 3 to be described later is placed and fastened is provided on the front end surface of the flange portion 12 (see FIGS. 1 and 3).

A hole portion 19 penetrating in the front-rear direction is provided in the front end surface of the body portion 11. A detection part 34 of the actuator 3 to be described later is inserted into the hole portion 19. The hole portion 19 is configured to communicate with an internal space of the hood portion 11a.

A substantially cylindrical recessed portion 20 into which a projection portion 32 of the actuator 3 to be described later is fitted is provided in an upper end surface of a front end portion (body portion 11) of the hood portion 11a. The recessed portion 20 is provided with a through hole 21a penetrating through a bottom wall (that is, the hood portion 11a) of the recessed portion 20 in the upper-lower direction so as to communicate a recessed space 21 with an internal space of the hood portion 11a.

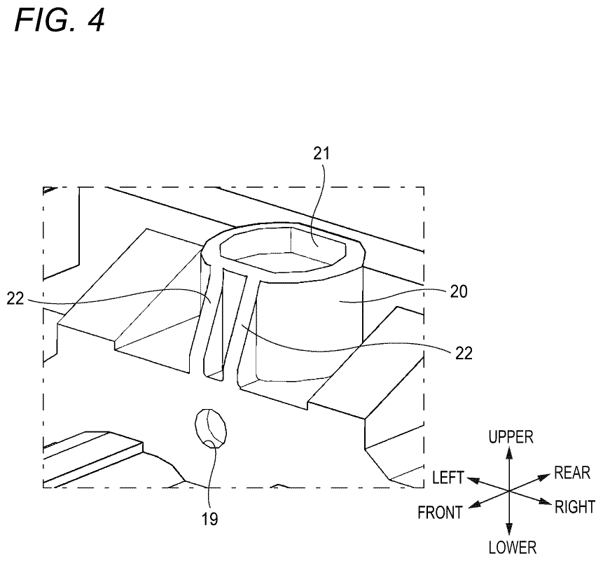

In the recessed portion 20, a guide portion 22 for guiding the detection part 34 of the actuator 3 to be described later to the hole portion 19 is provided in a front region of a peripheral wall thereof. As illustrated in FIG. 4, the guide portion 22 is formed of a pair of ribs, and an upper end surface thereof is connected to an opening end of the recessed portion 20 and the front end surface of the body portion 11, and is inclined downward from a rear side toward a front side. In other words, the guide portion 22 is formed with an inclined surface that guides the detection part 34 to the hole portion 19. The pair of ribs constituting the guide portion 22 are arranged side by side at a predetermined interval in the left-right direction.

Next, the actuator 3 will be described. The actuator 3 has a function (hereinafter referred to as a “come-off prevention function”) of preventing separation of the counterpart housing from the housing 2 when the actuator 3 is assembled to the housing 2 and the housing 2 and the counterpart housing are fitted to each other.

As illustrated in FIGS. 1 and 2, the actuator 3 includes the body portion 31, the projection portion 32 protruding downward from the body portion 31 in a rear region in the front-rear direction, a support portion 33 protruding downward from the body portion 31 in a substantially central portion in the front-rear direction, and the fastening portions 35 protruding in the left-right direction from both left and right side faces of the body portion 31.

The body portion 31 is, for example, a box-shaped resin housing. A control device that controls various operations of the actuator 3 and the like are accommodated in the body portion 31. An operation example of the actuator 3 will be described later.

The projection portion 32 is supported by the body portion 31, and includes a large-diameter portion 32a that is inserted into the recessed space 21 of the recessed portion 20 of the housing 2, and a small-diameter portion 32b that is positioned below the large-diameter portion 32a and inserted into the through hole 21a to be inserted into the internal space of the hood portion 11a. The large-diameter portion 32a is configured to be able to fit into the recessed portion 20 and has a function of positioning the actuator 3 with respect to the housing 2. For example, the small-diameter portion 32b is configured to be displaceable (raised and lowered) in the upper-lower direction by being controlled by the control device or the like, and has a come-off prevention function of preventing separation of the counterpart housing from the housing 2 when the housing 2 and the counterpart housing are fitted to each other.

The support portion 33 supports the detection part 34 that has a cylindrical pin shape elongated in the front-rear direction and is inserted into the hole portion 19. The support portion 33 is provided with a biasing member (for example, a spring or the like) that biases the detection part 34. The detection part 34 has a function of detecting fitting between the housing 2 and the counterpart housing. The detection part 34 is connected to, for example, the control device or the like, and detects the fitting between the housing 2 and the counterpart housing. The detection part 34 is configured to be displaceable in the front-rear direction by being biased by the biasing member.

The fastening portion 35 is placed on the support portion 14 of the housing 2, and a fastening member such as a bolt is inserted therethrough. That is, the fastening portion 35 is formed to assemble the actuator 3 to the housing 2.

The housing 2 and the actuator 3 constituting the connector 1 have been described above. In order to obtain the connector 1 including the housing 2 and the actuator 3, it is necessary to assemble the actuator 3 to the housing 2. Hereinafter, a method for manufacturing the connector 1 will be described.

First, the terminals corresponding to the terminal accommodating chambers 16 and 18 of the housing 2 are accommodated. Next, the actuator 3 is disposed above the housing 2 such that a rear region of the actuator 3 in the front-rear direction corresponds to the notch portion 13 of the housing 2 and the projection portion 32 of the actuator 3 corresponds to the recessed portion 20 of the housing 2.

Next, the housing 2 and the actuator 3 are brought close to each other in the upper-lower direction so that the projection portion 32 is fitted into the recessed portion 20. Then, the detection part 34 of the actuator 3 comes into contact with an upper end of the guide portion 22 of the housing 2. In this state, when the housing 2 and the actuator 3 are further brought closer to each other in the upper-lower direction, the detection part 34 is guided to the hole portion 19 by sliding on the inclined surface formed on the guide portion 22, and is inserted into the hole portion 19. A front end portion of the detection part 34 inserted into the hole portion 19 is positioned in a front region in the front-rear direction of the internal space of the hood portion 11a (see FIG. 2).

The fastening portion 35 of the actuator 3 is placed on the support portion 14 of the housing 2. The actuator 3 is assembled to the housing 2 by fastening the fastening portion 35 and the support portion 14 by the fastening member. Thus, the connector 1 is completed.

At this time, the projection portion 32 and the recessed portion 20 are fitted to each other such that a lower end surface of the large-diameter portion 32a and a bottom surface of the recessed portion 20 are spaced apart from each other by a predetermined distance in the upper-lower direction and a lower end surface of the small-diameter portion 32b and an upper surface of the first terminal accommodating portion 15 are spaced apart from each other by a predetermined distance (see FIG. 2).

The method for manufacturing the connector 1 has been described above. The actuator 3 assembled to the housing 2 has the come-off prevention function of preventing the separation of the counterpart housing from the housing 2 when the housing 2 and the counterpart housing are fitted together. Hereinafter, an operation example related to the come-off prevention function of the actuator 3 will be described.

In the connector 1 according to the present embodiment, it is necessary to fit the housing 2 and the counterpart housing in order to connect the connector 1 and the counterpart connector. To fit the housing 2 and the counterpart housing, first, the counterpart housing is disposed behind the housing 2.

Next, the housing 2 and the counterpart housing are brought close to each other in the front-rear direction, and a hood portion (not illustrated) of the counterpart housing is inserted into the hood portion 11a of the housing 2. The hood portion of the counterpart housing is provided with a through hole penetrating in the upper-lower direction at a position corresponding to the projection portion 32 (small-diameter portion 32b) when the housing 2 and the counterpart housing are fitted to each other.

When the insertion of the hood portion of the counterpart housing into the hood portion 11a is continued, the housing 2 and the counterpart housing are fitted to each other. When the housing 2 and the counterpart housing are fitted to each other, the actuator 3 detects the fitting of the housing 2 and the counterpart housing by the detection part 34 inserted into the hole portion 19.

When the fitting between the housing 2 and the counterpart housing is detected, for example, the small-diameter portion 32b of the projection portion 32 is lowered by a predetermined amount by the control device or the like of the actuator 3 and is inserted (inserted) into the through hole provided in the hood portion of the counterpart housing. As a result, the small-diameter portion 32b and the through hole of the counterpart housing are locked (fitted), and the separation of the counterpart housing from the housing 2 is prevented.

On the other hand, when the counterpart housing is desired to be separated from the housing 2, a signal may be sent to the control device or the like of the actuator 3 to raise the small-diameter portion 32b of the projection portion 32, thereby releasing the locking (fitting) between the small-diameter portion 32b and the through hole of the counterpart housing. When the housing 2 and the counterpart housing are relatively moved away from each other in the front-rear direction in a state where the lock (fitting) is released, the separation of the counterpart housing from the housing 2 is prevented.

A method for sending a signal to the control device or the like of the actuator 3 can be appropriately set, and thus a description thereof will be omitted. An operation example related to the come-off prevention function of the actuator 3 has been described above.

According to the connector 1 of the present embodiment, when the actuator 3 is assembled to the housing 2, the guide portion 22 guides the detection part 34 to the hole portion 19. Accordingly, when the actuator 3 is assembled to the housing 2, interference of the detection part 34 with a portion of the housing 2 other than the hole portion 19 and the guide portion 22 is prevented. That is, the connector 1 according to the present embodiment is superior to a connector of the related art in workability of the assembly work of the actuator 3 to the housing 2, and the like.

According to the connector 1 of the present embodiment, the projection portion 32 of the actuator 3 and the recessed portion 20 of the housing 2 are configured to be fitted to each other. Accordingly, when the actuator 3 is assembled to the housing 2, positioning can be performed by the projection portion 32 and the recessed portion 20. Further, since the projection portion 32 and the recessed portion 20 are fitted to each other, the separation of the actuator 3 from the housing 2 is prevented.

According to the connector 1 of the present embodiment, the detection part 34 is formed of a cylindrical pin, and the guide portion 22 is formed of a pair of ribs. Accordingly, the guide portion 22 can guide the detection part 34 to the hole portion 19 with a simple shape. Further, for example, by setting a distance between the pair of ribs of the guide portion 22 to be slightly smaller than a diameter of the detection part 34, a lower end on a rear end portion of the detection part 34 at a portion where the detection part abuts against the guide portion 22 is sandwiched between the pair of ribs. Accordingly, the connector 1 according to the present embodiment can more accurately guide the detection part 34 toward the hole portion 19 by the guide portion 22.

### Other Embodiments

The present invention is not limited to the embodiment described above and can be appropriately modified, improved and the like. In addition, materials, shapes, sizes, numbers, arrangement positions, or the like of components in the embodiment described above are freely selected and are not limited as long as the present invention can be implemented.

In the embodiment described above, the recessed portion 20 is provided on the upper end surface of the front end portion (body portion 11) of the hood portion 11a, but the recessed portion 20 may be provided on a left end surface or a right end surface of the front end portion (body portion 11) of the hood portion 11a, for example. In this case, the actuator 3 is disposed on the left side or the right side so as to correspond to the recessed portion 20.

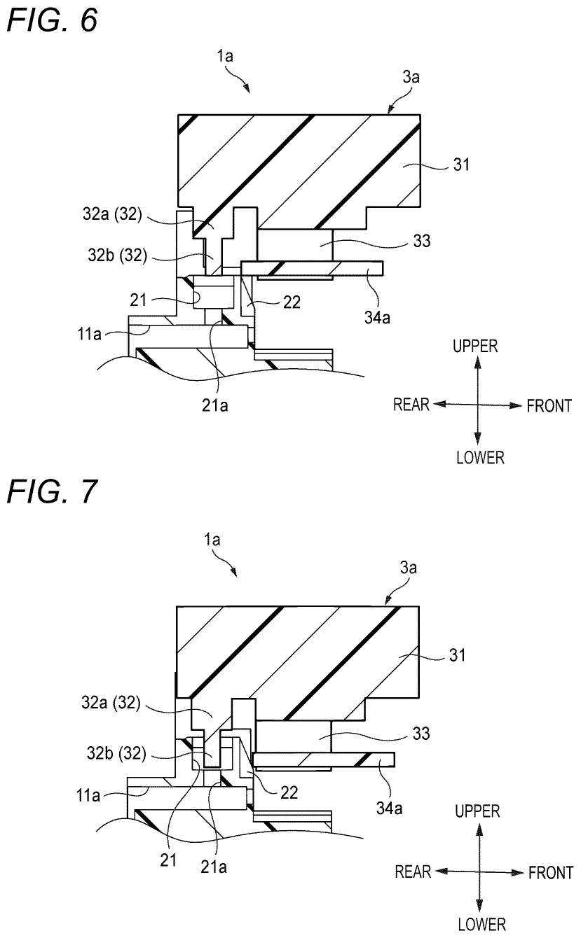

A connector 1a according to another embodiment will be described with reference to FIGS. 6 to 8. The same components as those of the embodiment described above are denoted by the same reference numerals, and the description thereof will be omitted as much as possible. The difference in configuration between the connector 1 and the connector 1a is only a detection part 34a of an actuator 3a. Therefore, the description of the actuator 3a and the housing 2 except for the detection part 34a will be omitted.

The detection part 34a has a cylindrical pin shape extending in the front-rear direction, and is supported by the support portion 33 so as to be displaceable in the front-rear direction. Accordingly, the connector 1a facilitates the assembly work of the actuator 3a to the housing 2, and is excellent in workability. An assembly step of the actuator 3a to the housing 2 will be described as an example.

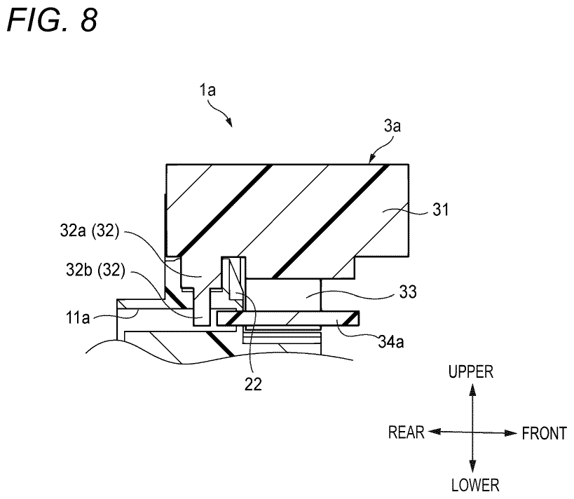

First, when the actuator 3a disposed at a predetermined position above the housing 2 is brought close to the housing 2, a lower end on a rear end portion of the detection part 34a abuts against the upper end surface (a starting portion of the inclined surface) of the guide portion 22 (see FIG. 6). When the actuator 3 is moved downward in this state, the detection part 34a is displaced so as to be pushed forward while sliding along the inclined surface of the guide portion 22 (see FIG. 7). When the actuator 3 continues to move downward, the detection part 34a passes through the guide portion 22 and reaches the front of the hole portion 19. When the detection part 34a pushed forward is operated rearward, the detection part 34a is inserted into the hole portion 19 (see FIG. 8).

Since the detection part 34a is configured to be displaceable in the front-rear direction in this manner, the assembly work of the actuator 3a to the housing 2 is facilitated. That is, the connector 1 according to the other embodiment is superior to the connector of the related art in workability of the assembly work of the actuator 3a to the housing 2, and the like.

Here, characteristics of the connector according to the present embodiment described above are briefly summarized and listed in the following [1] to [4].

[1] A connector (1) including:
a housing (2) fitted to a counterpart housing; and
an actuator (3) assembled to the housing along an intersecting direction with a fitting direction of the housing and the counterpart housing, wherein
the actuator (3) includes
   a detection part (34) configured to detect fitting of the housing and the counterpart housing, and
the housing (2) includes
   a hole portion (19) into which the detection part is inserted, and
   a guide portion (22) inclined to guide the detection part to the hole portion when the actuator is assembled to the housing.

[2] The connector (1) according to the above [1], wherein
the actuator (3) includes a projection portion (32) protruding in the intersecting direction, and
the housing includes a recessed portion (20) fitted to the projection portion.

[3] The connector (1) according to the above [1], wherein
the detection part (34) is a cylindrical pin, and
the guide portion (22) is a pair of ribs.

[4] The connector (1) according to the above [1], wherein
the detection part (34a) is configured to be displaceable in the fitting direction.

According to the connector having the configuration of the above [1], the actuator assembled to the housing fitted to the counterpart housing includes the detection part that is inserted into the hole portion of the housing to detect the fitting between the housing and the counterpart housing. Further, the housing includes the guide portion inclined to guide the detection part to the hole portion when the actuator is assembled to the housing. Accordingly, when the actuator is assembled to the housing, interference of the detection part with a portion of the housing other than the hole portion and the guide portion is prevented. That is, the connector having the above configuration is superior to the connector of the related art in workability of the assembly work of the actuator to the housing, and the like.

According to the connector having the configuration of the above [2], the projection portion of the actuator and the recessed portion of the housing are fitted to each other. Accordingly, when the actuator is assembled to the housing, positioning can be performed by the projection portion and the recessed portion. Further, since the projection portion and the recessed portion are fitted to each other, the separation of the actuator from the housing is prevented.

According to the connector having the configuration of the above [3], the detection part is the cylindrical pin, and the guide portion is the pair of ribs. Accordingly, the guide portion can guide the detection part to the hole portion with a simple shape. Further, for example, by setting a distance between the pair of ribs of the guide portion to be slightly smaller than a diameter of the detection part, a lower region in the front-rear direction of the detection part at a portion where the detection part abuts against the guide portion is sandwiched between the pair of ribs. Accordingly, the connector 1 according to the present configuration can more accurately guide the detection part toward the hole portion by the guide portion. That is, when the actuator is assembled to the housing, the interference of the detection part with a portion of the housing other than the hole portion and the guide portion is prevented.

According to the connector having the configuration of the above [4], since the detection part is configured to be displaceable in the fitting direction, the assembly work of the actuator to the housing is facilitated.

Although the present invention has been described in detail with reference to a specific embodiment, it is apparent to those skilled in the art that various changes and modifications can be made without departing from the spirit and scope of the present invention.

The present application is based on a Japanese patent application (Japanese Patent Application No. 2022-034639) filed on Mar. 7, 2022, contents of which are incorporated herein by reference.

### INDUSTRIAL APPLICABILITY

According to one embodiment, it is possible to provide a connector that is excellent in workability in an assembly work of an actuator to a housing. The present invention having this effect is useful for a connector.

What is claimed is:

1. A connector comprising:
a housing fitted to a counterpart housing; and
an actuator assembled to the housing along an intersecting direction with a fitting direction of the housing and the counterpart housing, wherein
the actuator includes
a detection part configured to detect fitting of the housing and the counterpart housing, and
the housing includes
a hole portion into which the detection part is inserted, and
a guide portion inclined to guide the detection part to the hole portion when the actuator is assembled to the housing.

2. The connector according to claim 1, wherein
the actuator includes a projection portion protruding in the intersecting direction, and
the housing includes a recessed portion fitted to the projection portion.

3. The connector according to claim 1, wherein
the detection part is a cylindrical pin, and
the guide portion is a pair of ribs.

4. The connector according to claim 1, wherein
the detection part is configured to be displaceable in the fitting direction.
